(19) United States
(12) Patent Application Publication
(10) Pub. No.: US 2008/0053155 A1
(43) Pub. Date: Mar. 6, 2008

(54) Optical fiber preform having large size soot porous body and its method of preparation

(76) Inventor: Sanket Shah, Aurangabad, Maharashtra (IN)

Correspondence Address: James Ray & Associates, 2640 Pitcairn Road, Monroeville, PA, 15146, US

(21) Appl. No.: 11/596,162

(22) PCT Filed: Sep. 4, 2006
(86) PCT No.: PCT/IN06/00334

§ 371 Date: Jan. 22, 2007

(51) Int. Cl. G02B 6/02; C03B 37/018; B32B 17/06; B32B 9/00

(52) U.S. Cl. 65/421; 428/428; 385/123

(57) ABSTRACT

A method for producing an optical fiber preform having a large size soot porous body is provided wherein opposite ends of the rod are heated by heating means to achieve a predetermined temperature which is increased in a controlled manner in a stepwise mode or a gradual mode or a non-linear mode by varying flow rate and/or ratio of oxyhydrogen gases to heating means to achieve a particular temperature and soot porous body of desired diameter. In one embodiment, the predetermined temperature is increased to achieve a particular temperature and an intermediate diameter of soot porous body, wherein the particular temperature is optionally maintained till a soot porous body of a desired diameter is produced which is subjected to sintering process to produce the optical fiber preform having a large size soot porous body.

### FIELD OF THE INVENTION

The present invention relates to an optical fiber preform having large size soot porous body and its method of preparation. Particularly it relates to an optical fiber preform having soot porous body of larger size diameter without cracks or breakages or damages or bends or splits or slippages at opposite end points of the preform and its method of preparation. More particularly it relates to a method for depositing soot porous body of larger size diameter preferably more than about 130 mm, more preferably varying between about 130 mm to about 190 mm diameter on a target rod to form an optical fiber preform having no cracks, breakages, damages, bends, splits or slippages at its opposite end portions, and the optical fiber preform and optical fiber produced thereby.

### BACKGROUND OF THE INVENTION

Optical fibers are inherently versatile as a transmission medium for all forms of information, be it voice, video or data. The optical fibers are drawn from an optical fiber preform. The optical fiber of predetermined dimension is drawn from the optical fiber preform by subjecting one end of the preform to a high temperature, for example above 2000° C. Under such a high temperature, the tip of the preform softens, from which a thin fiber of desired dimension is drawn. The different methods employed in manufacture of these preforms are described in the literature.

The optical fiber preform can be manufactured by different methods of chemical vapour deposition (CVD). The optical fiber preform manufacturing process primarily involves a step of preparing the core rod consisting of core of the fiber and part of clad which may be followed by over-cladding. The core rod can be prepared by methods known in the art, such as modified chemical vapour deposition (MCVD), plasma chemical vapour deposition (PCVD), outside vapour deposition (OVD), vapour axial deposition (VAD) etc. The over-cladding of the core rod can also be carried out by various methods, such as glass tube jacketing, OVD soot over-cladding, VAD soot over-cladding, plasma over-cladding etc. The optical fiber preform can be manufactured by any combination of the core rod manufacturing methods and the over-cladding preparation methods.

The most commonly used manufacturing process is the MCVD process, which as compared to OVD is simpler in nature. However, due to wide flexibility, the OVD process has been successfully industrialized and is now preferred over MCVD for manufacturing wide range of optical fibers, such as single-mode fibers, long-distance, graded-index multimode fibers, short-distance fibers etc.

In the OVD method, a flame hydrolysis burner fabricates the soot glass particles on the surface of the core rod consisting of core. The chemical reactants involved in the formation of soot particles are silicon tetrachloride [SiCl₄], oxygen [O₂] and oxyhydrogen burner gases. SiCl₄ vapours react with O₂ with the help of oxyhydrogen flame to form sub micrometer sized SiO₂ glass particles in a reaction, which is expressed as follows:
SiCl₄(g)+2H₂(g)+O₂(g)→SiO₂(s)+4HCl(g)

The above mentioned deposition process occurs till the desired amount of glass particles have been deposited and then the soot porous body is moved into sintering furnace, where the deposited soot layer is dried with chlorine atmosphere and then sintered to form a solid glass preform in a helium atmosphere at about 1500° C. The sintered preform is drawn into an optical fiber, which consists of core and clad.

In a typical conventional method for depositing soot particles onto a target rod, a system elaborated in accompanying FIG. 1 is employed, wherein glass soot is deposited on the target rod 101 to form soot porous body 104. In this method the soot deposition is accomplished by traverse motion of the target rod 101 over the burner 103 as shown by arrow 111 and rotational motion of the rod 101 as shown by arrow 112 in FIG. 1. The target rod 101 is mounted on a movable glass-working lathe 100 between chucks 102 and 105 over the soot depositing burner 103, which may be one or more in number. The glass-working lathe is enclosed inside the gas cabinet 107 provided for the purpose. The cabinet 107 is provided with an exhaust duct 106 to remove un-deposited reactant gases and soot particles. The rod 101 is made to rotate in the direction of arrow 112 at a higher speed preferably above 150 rpm at initial deposition and later on this rotational speed is allowed to reduce upto 100 rpm or lower. The target rod 101 also traverses along its own axis as shown by arrow 111 over the burner 103 which is kept stationary. In one arrangement with modifications of system shown in FIG. 1, it is possible to move the rod 101 and the burner 103, but in opposite directions to each other or to move the burner 103 and to keep the rod 101 stationary in both cases while rotating the rod 101 onto its own axis in the direction as shown by arrow 112.

During the traverse passes, whether the rod 101 traverses and/or burner 103 traverses, SiCl₄ vapours are supplied from the burner 103 along with oxyhydrogen fuel from the delivery line 108 onto the rod 101 to react SiCl₄ with oxygen to form soot porous body 104 on the target rod 101. The doping to increase the refractive index of the glass soot deposit is achieved by supplying GeCl₄ vapours from the burner 103 along with oxygen.

The soot deposition step is continued till the desired amount of the soot particles is deposited onto the target rod and the target rod with deposited soot porous body is moved into sintering furnace, where the deposited soot is dried with chlorine atmosphere and then sintered in a helium atmosphere at about 1500° C. to form a solid glass preform. The sintered preform is drawn into an optical fiber, which consists of core and clad.

It has been observed that during the deposition of soot porous body by employing above discussed OVD method, if the heating is inadequate at a point of the rod/mandrel, a crack or breakage can be initiated at that point of the rod/mandrel, and in case the heating is excessive, then the removal of the rod/mandrel becomes difficult and is generally not possible without damaging the inner surface of the soot perform. The problems of cracking, breakage, damages, and also bending, splits or slippages occur generally at the two opposite ends of the rod/mandrel. The terms cracks, breakages, damages, bends, splits or slippages as used herein have the same meaning as known in the art in the field of optical fiber preform.

It has been further observed that the problem of cracking or breaking or damaging or bending in the deposited soot is further increased with the increase in the diameter of the soot being deposited. Therefore, this method is not suitable for depositing the soot porous body having a diameter of more than 60 mm without developing cracks or breakages or damages or bends at the end portions of the preform. To avoid these problems one or two end burners are provided at the opposite ends of the rod, which provide heat to the ends of the rod which in-turn avoids cracks, breakages, damages, bending, splits and slippages at the ends of the rod.

One of the known methods employing principles of OVD method, as discussed hereinabove, for manufacturing the optical fiber preform having soot deposited involves supplying of glass forming material onto a rod through a burner to form soot porous body over the target rod. In one such known method [U.S. Pat. No. 4,453,961], the provision of one or more end burners has been taught. This method only discloses provision of end burners, but does not teach the manner to employ these end burners to avoid cracking, breakage, bending, damage, splitting and slippage problems in case the soot porous body having a diameter of more than 60 mm is required to be deposited on the rod. Accordingly, the main drawback of this known method is that it only results in soot deposition upto 60 mm diameter. To achieve soot deposit of this diameter, oxygen is supplied at 1.4 slpm [standard liters per minute].

It has been further observed that the main object of this method is to close the aperture of the preform prepared and to avoid contaminants during such step, and the main purpose of the end torches/burners provided in this method is to close the aperture in the start rod and not to avoid the cracks or breakages or damages or bends in the deposited soot.

Accordingly, the above method cannot be employed to have a soot porous body of a diameter of more than about 60 mm, preferably of a diameter more than about 130 mm, more preferably of a diameter upto about 190 mm.

In another known method [U.S. Pat. No. 4,714,488], wherein provision of end burners has been taught, the preform having soot deposited on a rod could be prepared with increased diameter, but only upto the diameter of 130 mm. This method also does not teach how to have an optical fiber preform having a large size soot porous body having a diameter of more than about 130 mm, preferably a diameter varying upto about 190 mm. In this method the fuel gas/oxygen are supplied at a rate varying between 0.37 to 2.42/0.49 to 2.27 l/min for end burners.

It has been observed that main purpose of the end burners in this method is to control the temperature of part of the soot and to cause hardness of the soot in this part. But this method neither teaches the manner to control the temperature to achieve the hardness of the soot in its particular part nor teaches how to have soot porous body having a diameter of more than about 130 mm.

Further, the above method additionally suffers from major drawback of loss of germanium due to low temperature zone of the preform. This problem has been overcome in this method, but by traveling the chemical burners beyond end of the rod and by oscillating the other chemical burners resulting increase of overall cost of production of optical fiber preform. Accordingly, there is no indication in this method that how deposition of soot porous body having a diameter of more than about 130 mm, preferably upto a diameter of about 190 mm can be achieved without having cracks or breakages or damages or bends or splits at its opposite ends.

Yet another known method [U.S. Pat. No. 6,789,401 B1], employing CVD (OVD) technology for coating the soot particles on a rod/mandrel wherein provision of end burners has been described, is observed to have a main object of increasing the deposition rate or deposition efficiency and not the thickness or diameter of the soot deposit. There is no indication in this method that whether the increase in deposition rate or efficiency will also result in increase in thickness or diameter of soot deposited. Further, as per this method, the temperature of the workpiece (rod) is controlled by number of vents preferably provided in two rows in the cabinet and not by the end burners. Accordingly, the cracks, breakages, bending, splits and slippages are not reduced at the ends of the resulted preform particularly when it is required with soot porous body of diameter of more than about 130 mm, particularly of a diameter upto about 190 mm.

In accordance with this method, the end burners are to provide heat onto the ends of the rod to avoid breaking and/or cracking, but no mechanism has been taught to control the temperature at the ends of the rod by the end burners. On the contrary, it has been observed in this method that if the end burners provide excessive heat on ends of the rod, the rod bends at the ends. This method does not teach how to overcome this problem of bending of ends of the rod.

Therefore, no manner to achieve the soot deposit having higher thickness or diameter of more than about 130 mm, particularly a diameter upto about 190 mm without cracks, breakages, bends, damages and splits has been taught in this method.

It has been further observed in this method that additional heat at the ends of the workpiece generally decreases the temperature gradient between the silica soot particles and the workpiece, and thereby, decreases the thermophoretic effect. The reduction in the thermophoretic effect causes a reduction in the deposition efficiency at the ends of the workpiece. The diameter at the ends therefore increases even more slowly than at other location on the workpiece. This in-turn also results in problem of increased tapering effect at the ends in-addition to cracks, breakages and bending.

The term tapering effect as used herein means cone shape and not the cone length.

This method does overcome above problem of reduction in deposition rate/efficiency, but by increasing the rotation speed of the workpiece greater than about 60, preferably about 80 rotations per minute (RPM) to maintain a substantial thermophoretic effect between the soot particles and the workpiece. The rotational speed at 80 rpm or above may result in non-uniform deposition which in-turn may cause ovality or high core/clad concentricity.

It has now been observed that even above known methods employing one or two end burners still continue to suffer from the problems of cracking, breakage, damage, bending, split or slippage in the soot porous body at the opposite end portions. These problems are further enhanced in case the heating at the end portions of the rod is inadequate. Further, in case the heating is excessive, then removal of the rod/mandrel becomes difficult without damaging the inner surface of the soot perform.

Accordingly, it is understood from above description that the prior art only provides provision for end burners, but these end burners as provided in the prior art are not capable of overcoming the problems of cracking, breakage, damage, bending, splitting or slippage of the soot porous body at the opposite end portions of the rod/mandrel. Further, if one or more of these problems are coupled with tapering effect at the end portions then the overall process for manufacturing the preform becomes redundant and highly uneconomical. It has also been observed that these problems are further increased when the soot deposit is required beyond the diameter of about 130 mm, particularly upto a diameter of about 190 mm and hence the known methods result in increase of overall cost of producing the optical fiber due to wastage of opposite end portions of the preform.

Therefore, the known methods of the prior art do not teach how to produce an optical fiber preform having a large size soot porous body particularly of a diameter of more than about 130 mm, more particularly of a diameter varying between about 130 mm to about 190 mm without the problems of cracking, breakage, bending, damage, split or slippage at opposite ends of the soot porous body of the preform.

### Need of the Invention

Accordingly, there is a need to have a method which can teach how to produce an optical fiber preform having a large size soot porous body particularly of a diameter of more than about 130 mm, more particularly of a diameter varying between about 130 mm to about 190 mm without the problems of cracking, breakage, bending, damage, split or slippage at opposite ends of the soot porous body of preform and at the same time the preform produced thereby is capable of resulting in an optical fiber having desired physical and functional characteristics.

### Objects of the Invention

The main object of the present invention is to provide a method for producing an optical fiber preform having a large size soot porous body particularly a soot porous body of a diameter of more than about 130 mm, more particularly a soot porous body of a diameter varying between about 130 mm to about 190 mm without the problems of cracking, breakage, bending, damage, split and slippage at opposite ends of the soot porous body of preform.

This is another object of the present invention to provide a method for producing an optical fiber preform having a large size of soot porous body to make the process highly economical and avoiding wastage of end portions of the preform.

This is still an object of the present invention to provide a method for producing an optical fiber preform which is capable of producing an optical fiber having desired physical and functional characteristics in-addition to having a large size of soot porous body of a diameter of more than about 130 mm, particularly of a diameter varying between about 130 mm to about 190 mm.

### BRIEF DESCRIPTION OF THE INVENTION

The prior art methods have made an attempt to overcome problems of cracking, breakage, damage, bending, split or slippage in the soot porous body at the opposite end portions of the rod by employing one or two end burners towards the opposite ends of the rod, but as explained hereinabove, these known methods have not been able to overcome these problems satisfactorily and still continue to suffer from said problems. The said problems are particularly observed when an attempt is made to have a soot porous body of larger diameter, more particularly a soot porous body of a diameter of more than about 130 mm, specifically a soot porous body of a diameter varying from about 130 mm to about 190 mm.

The present invention which is aimed to overcome above problems of the prior art, provides a method for producing an optical fiber preform which can overcome above described problems of the prior art, that is can produce an optical fiber preform having a large size soot porous body, particularly having a diameter of more than about 130 mm, more particularly having a diameter varying from about 130 mm to about 190 mm without formation of cracks, breakages, bends, damages, splits and slippages at opposite ends of the soot porous body of the preform.

It has been surprisingly observed by the inventors of this invention that when the opposite ends of the rod are heated after attaining a predetermined temperature (lower temperature) at the opposite ends to achieve a particular temperature (higher temperature) while increasing the said predetermined temperature gradually or in stepwise mode or in non-linear mode in a controlled manner, the problems of formation of cracks in the deposited soot, occurrence of breakage in the soot deposited and split in the soot porous body along the length of the rod are minimized to a negligible extent thereby making the overall process not only useful, but also highly economical.

Further, when the particular temperature is achieved while depositing the soot particles in accordance with the present invention, the removal of rod with soot porous body also becomes easier that's too without damaging the inner surface of the soot preform.

It has also been surprisingly observed that when desired particular temperature at the ends of the rod is achieved by controlling the flow rate of oxygen gas and fuel gas to the heating means, such as end burners, oxy-hydrogen burner/torch, plasma torch, furnace, etc. it in-turn results in controlling the heating of the opposite ends of the rod and achieving the desired particular temperature at the opposite ends of the rod in a controlled manner thereby avoiding the problems of formation of cracks in the deposited soot, occurrence of breakage in the soot deposited and split in the soot porous body along the length of the rod, and making its removal easier without damaging the soot preform.

Accordingly, in one embodiment, the present invention relates to a method for producing an optical fiber preform having a large size soot porous body comprising the following steps:
a) mounting a rod on the chucks and of a movable lathe provided with means to rotate the rod onto its own longitudinal axis in the direction shown by arrow, means to traverse the rod along its own longitudinal axis in the direction shown by arrow, one or more soot forming burners provided with means to traverse the burner along the longitudinal axis of said rod and supply means to supply reactant gases, and one or more heating means provided towards opposite ends of said rod, wherein the heating means are provided with means to supply oxygen and fuel gases, which in-turn are provided with means to control the flow rate of oxygen and fuel gases and/or means to control the amount of oxygen and fuel gases;
b) rotating said rod onto its own longitudinal axis in the direction of arrow by said means to rotate and traversing said rod along its own longitudinal axis in the direction as shown by arrow by said means to traverse; and
c) directing glass forming soot materials from the soot forming burner to get deposited on the surface of said rod till desired amount of soot particles is deposited on said rod to have soot porous body of desired diameter which is transferred to a sintering furnace wherein the optical fiber preform of larger size is produced, characterized in that
   i) heating opposite ends of said rod by said heating means to achieve a predetermined temperature;
   ii) continuing said step of heating while maintaining said predetermined temperature of said opposite ends of said rod achieved in said step-i) till a soot porous body of a minimum diameter is formed;
   iii) continuing said step of heating while increasing said predetermined temperature of said opposite ends of said rod and while depositing the soot particles thereon to achieve a particular temperature and an intermediate diameter of the soot porous body;
   iv) optionally continuing said step of heating while maintaining said particular temperature of said opposite ends of said rod achieved in said step-iii) till a soot porous body of a desired diameter is formed.

Accordingly, in another embodiment, the present invention relates to a method for producing an optical fiber preform having large size soot porous body comprising following steps:
a) mounting a rod on the chucks of a movable lathe provided with means to rotate the rod onto its own longitudinal axis, means to traverse the rod along its own longitudinal axis, one or more soot forming burners provided with means to traverse the burner along the longitudinal axis of said rod and means to supply reactant gases, and one or more heating means provided towards opposite ends of said rod, wherein the heating means are provided with means to supply oxygen and fuel gases, which in-turn are provided with means to control the flow rate of oxygen and fuel gases and/or means to control the amount of oxygen and fuel gases;
b) rotating said rod onto-its own longitudinal axis by said means to rotate and traversing said rod along its own longitudinal axis by said means to traverse; and
c) directing glass forming soot materials from the soot forming burner to get deposited on the surface of said rod till desired amount of soot particles is deposited on said rod to have soot porous body of desired diameter which is transferred to a sintering furnace wherein the optical fiber preform of larger size is produced, characterized in that
   i) heating opposite ends of said rod by said heating means to achieve a predetermined temperature; and
   ii) continuing said step of heating while increasing said predetermined temperature of said opposite ends of said rod and while depositing the soot particles thereon to achieve a particular temperature and a desired diameter of soot porous body.

In accordance with one embodiment of the present invention the opposite ends of the rod are heated to a predetermined temperature of about 700° C., which is varied by varying flow rate of oxygen and fuel gases to the heating means.

In accordance with another embodiment of the present invention said predetermined temperature is increased to said particular temperature of about 1300° C. or more.

In accordance with still another embodiment of the present invention said predetermined temperature of the opposite ends of the rod is increased gradually or stepwise or non-linearly in a controlled manner.

In accordance with present invention, the heating means provided towards opposite ends of the rod may be selected from a group comprising end burners, oxy-hydrogen burner/torch, plasma torch, furnace, preferably the end burners, more preferably the end burners having provision for supply of one or more gases.

The other preferred embodiments and advantages of the present invention will be clear from the reading of following description in conjunction with the accompanying drawings which are not intended to limit scope of this invention.

### BRIEF DESCRIPTION OF THE ACCOMPANYING DRAWINGS

FIG. 1 is a schematic representation of soot over cladding of a target rod fitted in a movable lathe provided with end burners to form an optical fiber preform in accordance with one of the embodiments of the present invention.

FIG. 2 depicts the temperature profile of end burners in accordance with preferred embodiments of the present invention.

FIG. 3 shows an optical fiber preform having a large size soot porous body formed on a rod in accordance with the method of present invention.

FIG. 4 shows an optical fiber preform obtained in accordance with the method of present invention.

### DETAILED DESCRIPTION OF THE INVENTION

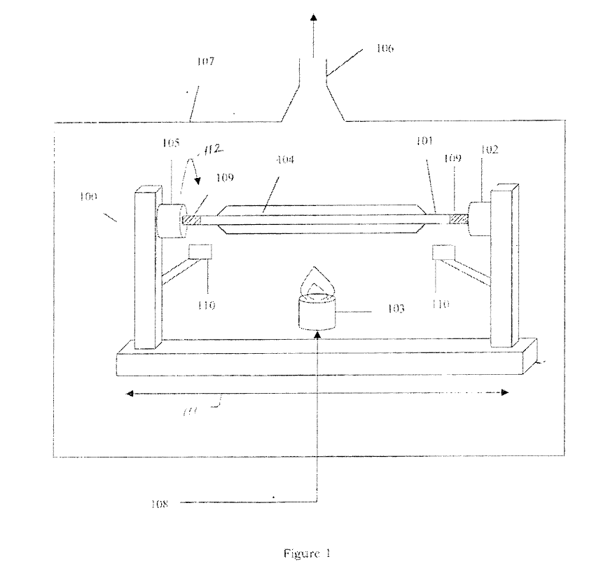

Now referring to accompanying FIG. 1, the end burners 110 are provided towards both opposite ends of the rod 101. The end burners 110 are fixed on the opposite vertical arms of the movable lathe 100 supporting the rod 101 between the chucks 102 and 105. As known in the art, the end burners are provided with means to supply oxygen and fuel gases, which in-turn are provided with means to control the flow rate of oxygen and fuel gases and/or means to control the amount of oxygen and fuel gases [not shown in the figure].

According to present invention, a method for producing an optical fiber preform having large size soot porous body is provided, comprising following steps:
a) mounting a rod 101 on the chucks 102 and 105 of a movable lathe 100 provided with means to rotate the rod onto its own longitudinal axis in the direction shown by arrow 112, means to traverse the rod along its own longitudinal axis in the direction shown by arrow 111, one or more soot forming burners 103 provided with means to traverse the burner along the longitudinal axis of said rod and supply means 108 to supply reactant gases, and one or more heating means 110 provided towards opposite ends of said rod 101, wherein the heating means 110 are provided with means to supply oxygen and fuel gases, which in-turn are provided with means to control the flow rate of oxygen and fuel gases and/or means to control the amount of oxygen and fuel gases;
b) rotating said rod onto its own longitudinal axis in the direction of arrow 112 by said means to rotate and traversing said rod along its own longitudinal axis in the direction as shown by arrow 111 by said means to traverse; and
c) directing glass forming soot materials from the soot forming burner 103 to get deposited on the surface of said rod 101 till desired amount of soot particles is deposited on said rod 101 to have soot porous body 104 of desired diameter which is transferred to a sintering furnace wherein the optical fiber preform 113 of larger size is produced, characterized in that
   i) heating opposite ends of said rod 101 by said heating means 110 to achieve a predetermined temperature;
   ii) continuing said step of heating while maintaining said predetermined temperature of said opposite ends of said rod 101 achieved in said step-i) till a soot porous body of a minimum diameter is formed;
   iii) continuing said step of heating while increasing said predetermined temperature of said opposite ends of said rod 101 and while depositing the soot particles thereon to achieve a particular temperature and an intermediate diameter of the soot porous body;
   iv) optionally continuing said step of heating while maintaining said particular temperature of said opposite ends of said rod 101 achieved in said step-iii) till a soot porous body of a desired diameter is formed.

The minimum diameter of soot porous body is about 35 mm. The scope of present invention is not restricted by selection of minimum diameter, which may be either low or more than about 35 mm, preferably about 35 mm, more preferably less than about 60 mm. The intermediate diameter of soot porous body is about 150 mm or more, preferably it is more than about 130 mm. It may be noted that the present method can be discontinued after attaining particular temperature and intermediate diameter in above step-iii).

According to present invention, a method for producing an optical fiber preform having large size soot porous body is provided, comprising following steps:
a) mounting a rod 101 on the chucks 102 and 105 of a movable lathe 100 provided with means to rotate the rod onto its own longitudinal axis in the direction shown by arrow 112, means to traverse the rod along its own longitudinal axis in the direction shown by arrow 111, one or more soot forming burners 103 provided with means to traverse the burner along the longitudinal axis of said rod and with supply means 108 to supply reactant gases, and one or more heating means 110 provided towards opposite ends of said rod 101, wherein the heating means 110 are provided with means to supply oxygen and fuel gases, which in-turn are provided with means to control the flow rate of oxygen and fuel gases and/or means to control the amount of oxygen and fuel gases;
b) rotating said rod onto its own longitudinal axis in the direction of arrow 112 by said means to rotate and traversing said rod along its own longitudinal axis in the direction as shown by arrow 111 by said means to traverse; and
c) directing glass forming soot materials from the soot forming burner 103 to get deposited on the surface of said rod 101 till desired amount of soot particles is deposited on said rod 101 to have soot porous body 104 of desired diameter which is transferred to a sintering furnace wherein the optical fiber preform 113 of larger size is produced, characterized in that
   i) heating opposite ends of said rod 101 by said heating means 110 to achieve a predetermined temperature; and
   iii) continuing said step of heating while increasing said predetermined temperature of said opposite ends of said rod 101 achieved in said step d) and while depositing the soot particles thereon to achieve a particular temperature and a desired diameter of soot porous body.

It may be noted that the rod may also be referred as core rod or target rod or as mandrel.

According to one embodiment of the present invention, the opposite ends of the rod are heated to a predetermined temperature of about 700° C. The said predetermined temperature of said opposite ends of the rod is increased by varying flow rate of oxygen and fuel gases to the end burners.

In accordance with preferred embodiment of this invention, the hydrogen and oxygen gas flow rates from heating means [end burners] are varied in a controlled manner to increase temperatures of ends of the rod in the desired controlled manner.

It may be noted that the present invention is not restricted by flow rate of gases to the heating means [end burners], because the flow rate of gas will depend upon the design of the heating means and distance of the heating means from the target rod. It has been observed that closer the heating means to the target rod slower is the flow rate of the gas. However, in accordance with one of the preferred embodiments of the present invention, the hydrogen and oxygen gas flow rates from heating means [end burners] are kept at about 25 slpm [standard liters per minute] and 14 slpm respectively, which are increased to about 45 slpm and 25 slpm respectively in a controlled manner. This increase in flow rates of hydrogen and oxygen gases will result in increase of temperatures of ends of the rod in the desired controlled manner.

The temperature at the ends of the rod can also be increased by varying oxygen/hydrogen ratios, for example from about 1.0 ratio to about 0.4 ratio. This variation of ratio of oxygen/hydrogen gases will also result in increase of temperature at the ends of the rod in the desired controlled manner.

In accordance with preferred embodiment of the present invention, said predetermined temperature is increased to said particular temperature of about 1300° C. or more. In accordance with the present invention said predetermined temperature of said opposite ends of the rod is increased gradually or stepwise or non-linearly in a controlled manner.

The present method can be performed by varying predetermined temperature of one or both heating means [end burners], preferably by varying predetermined temperature of both the heating means [end burners].

The predetermined temperature referred herein is about 700° C. or more. It may be noted that the present invention is not restricted by such predetermined temperature, which may even be lower than about 700° C.

The particular temperature referred herein to which said predetermined temperature is increased is about 1300° C. or more.

It has been observed that controlling the heating temperature of the end burners in accordance with the method of the present invention will result in a rigid connection between the soot particles and rod and also minimal stress on the glass rod thereby avoids split or crack or breakage or damage in the soot porous body formed on the rod by the present method.

It has also been observed that when the temperature at the ends of the rod 101 is kept on the lower side for example at about 700° C., there will be minimal stress on the glass rod but at the same time the density of the soot becomes so less that it will be unable to hold the grip between core and soot and will lead to split after certain passes of deposition or to slippage in sintering process. The problems of split and slippage can be overcome, but by keeping the temperature at the ends of rod towards higher side for example at about 1300° C. But an attempt to overcome the problems of split or slippage in the soot porous body results in stress on the ends of the rod thereby results in breakage or bending of the rod at the ends of the rod after certain amount of soot deposition, which in-turn makes it impossible to obtain the soot porous body of desired large diameter, preferably a diameter of more than about 130 mm, more preferably a diameter varying from about 130 to about 190 mm or more.

According to the present invention which overcomes above problems of split or slippage in the soot porous body; stress on the ends of the rod; and breakage or bending of the rod at the ends of the rod and still capable of producing a soot porous body of large size diameter of more than about 130 mm, preferably varying from about 130 mm to about 190 mm or more, the initial temperature or predetermined temperature at the ends of the rod is kept low for example at about 700° C. which is observed to avoid generation of stress on the glass rod, and the predetermined temperature at the ends of the rod is increased to higher temperature or a particular temperature for example to about 1300° C. in a stepwise mode or in a non-linear mode or gradually in a controlled manner till the ends of the soot preform deposition passes. The particular temperature at the ends of the rod is achieved by changing the flow rate and/or amount of the oxyhydrogen gases to the end burners. The present inventors have observed that as the temperature keeps on increasing with the growing soot size, the soot density will become higher and higher to keep sufficient holding between the rod and the soot porous body without causing the problems of cracking, breaking, bending, splitting or slippage in soot porous body formed during the present method.

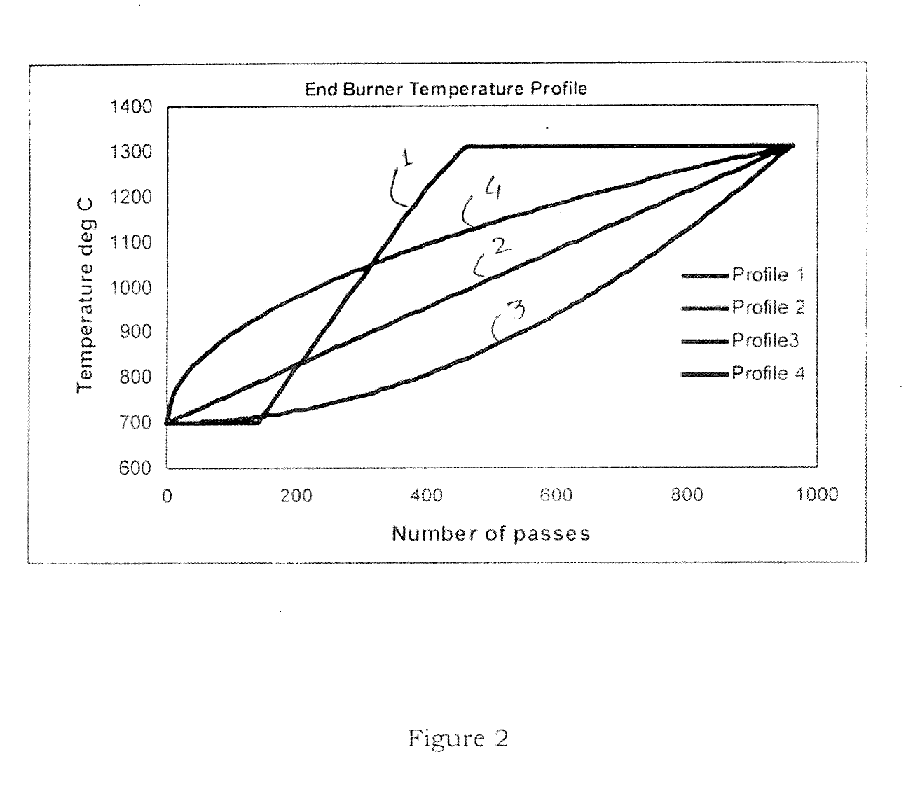

While the temperature at both ends of core rod is increased, during growing size of soot deposit, the heat is not fully directed on the rod and hence the possibility of crack or breaking or bending or splitting or slippage is totally eliminated. In accordance with the present invention, the temperature at the ends of the rod is kept in different profile as depicted in accompanying FIG. 2.

According to one of the preferred embodiments of the present invention, the temperature profile 1 of FIG. 2 is adopted wherein the start temperature or predetermined temperature of about 700° C. is maintained for growing a soot porous body upto a diameter of about. 35 mm followed by increasing said predetermined temperature to an end temperature or a particular temperature of about 1300° C. while depositing the soot particles to have a soot porous body of a diameter of about 150 mm or more, which is followed by depositing the soot particles till the soot porous body of the desired diameter of about 180 mm or more is achieved while maintaining said end temperature or particular temperature. It may be noted that in accordance with this embodiment, the soot particles deposition may be stopped after achieving first diameter of about 150 mm or more.

According to another preferred embodiment of this invention a temperature profile 2 or temperature profile 3 or temperature profile 4 is adopted wherein the start temperature or predetermined temperature of about 700° C. is achieved without depositing the soot particles followed by deposition of soot particles while increasing said start temperature or predetermined temperature to an end temperature or a particular temperature of about 1300° C. and while depositing the soot particles to have a soot porous body of a diameter of about 130 mm or more, preferably of a diameter varying from about 130 mm to about 190 mm or more. It may be noted that in accordance with this embodiment, the soot particles deposition may be stopped after achieving desired diameter of the soot porous body.

In accordance with the present invention, the predetermined temperature is increased to the end temperature in a stepwise mode or in a non-linear mode or gradually. The increase in temperature can be obtained by changing the flow rate of oxygen and fuel gases or by changing the ratio of oxygen and fuel gases.

In accordance with the preferred embodiment of this invention the hydrogen gas flow rate is varied from about 20 slpm to about 45 slpm and oxygen gas flow rate is varied from about 14 slpm to about 25 slpm.

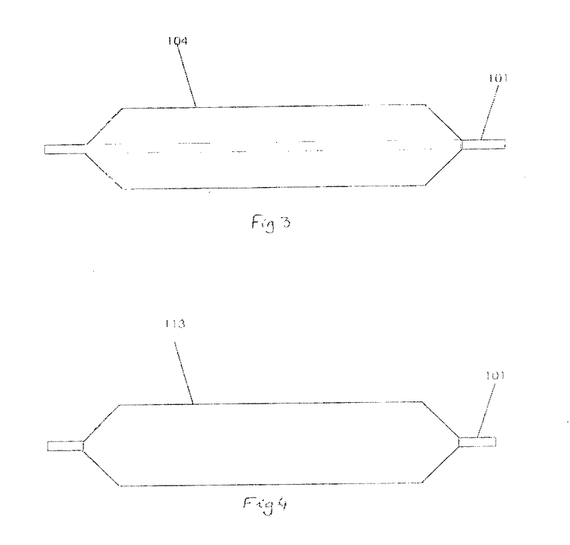

After deposition of the desired amount of soot particles, that is after formation of soot porous body 104 [FIG. 3] of desired diameter, preferably a soot porous body of a diameter of more than about 130 mm, more preferably a soot porous body of a diameter varying from about 130 mm to about 190 mm or more, the rod with soot porous body is transferred into the sintering furnace in which dehydration and sintering occurs in the known manner to form an optical fiber preform 113 of larger size [FIG. 4].

It may be noted that the present method can also be adopted if the soot porous body is required to be deposited to a diameter less than about 130 mm. Such deposition when carried out as per the method of the present invention has also been observed to be without split or crack or breakage or damage or slippage in the soot porous body formed on the rod.

The present method has been described for a system wherein the rod rotates onto its own longitudinal axis and simultaneously traverses along its own longitudinal axis. However, the present method is not restricted to such a system. In one embodiment, the present method is also applicable on a system wherein the rod is rotating onto its own longitudinal axis with the help of said means to rotate and stationary about its own longitudinal axis, but the soot forming burner is capable of traversing with the help of means to traverse the burner along the longitudinal axis of the rod.

In another embodiment, the present method is also applicable on a system wherein the rod is rotating onto its own longitudinal axis with help of said means to rotate and traversing along its own longitudinal axis with the help of said means to traverse the rod, and the soot forming burner also traverses along the longitudinal axis of the rod with the help of means to traverse the burner. In this embodiment, the rod and burner are made to traverse in opposite direction to each other.

The present method is not restricted by the speed of rotation and/or traverse of the rod and/or burner. The method of the present invention is capable of avoiding inadequate and excessive heating of end portions of the rod while depositing the soot particles thereon even upto the diameter of about 190 mm or more thereby avoiding all the problems associated therewith, that is, formation of crack in the deposited soot or breakage of soot deposited or split in deposited soot or bending at ends of rod or damage while removing rod with deposited soot porous body.

The problems associated with inadequate or excessive heating are avoided even for deposition of soot particles upto the diameter of about 190 mm or more onto a rod by the method of the present invention due to controlled heating of end portions of the rod. It has also been observed that the present process may also overcome problem of tapering effect [cone shape] at the end portions of the rod and the tapering effect may be reduced to a greater extent thereby making the overall process for manufacturing the optical fiber preform more useful and highly economical by avoiding wastage of preform at the end portions of the rod.

The word “about” as employed herein before a mathematical value of a parameter is intended to include permissible experimental and human error as allowed in the field of the art. The composition of the soot deposited including the dopant could be selected as per the requirement of physical and performance characteristics of the optical fiber. The dopant used for varying refractive index of glass may be selected from the group comprising GeCl₄, PoCl₃, BCl₃, BBr₃, SF₆, CF₄, CCl₂F₂, SiF₄, SOCl₂ and CCl₄ etc.

The present method can be adopted for producing optical fiber preform to manufacture any type of optical fiber, for example single mode fiber, multimode fiber etc.

In one particular embodiment of the present invention, a core rod diameter of about 20 mm is mounted on the movable lathe for deposition of soot particles by the present method. The reactant gases SiCl₄ and oxy-hydrogen gas are fed from the main burner to form soot porous body over the rod. The temperature of the main burner is kept around 1050±50 degree C. to react SiCl₄ with O₂ to form the SiO₂ (soot) on the core rod. The core rod is rotated at about 60 rpm and traverses at a speed of about 1500 mm/min. The two end burners are provided towards the opposite ends of the core rod to heat the opposite ends. The hydrogen gas flow rate is varied from about 20 slpm to about 35 slpm and oxygen gas flow rate is varied from about 14 slpm to about 20 slpm.

The present method results in increase of output yield of soot porous body [FIG. 3] which is about 80 to 95% due to elimination of above problems. This in-turn results in increase of manufacturing capacity of the production unit and makes the overall process highly economical to result in production of optical fiber preform [FIG. 4].

The present invention is now elaborated with the help of following examples which are not intended to limit the scope of the present invention, but are incorporated for the better understanding the manner to perform the present invention and to compare the same with the known methods.

Experiment 1:

A soot porous body was deposited by employing OVD method as known in the art on a core rod of diameter of about 20 mm fitted between the chucks of a movable lathe. The temperature of main burner was maintained at about 1050±50 degree C. to allow reaction of SiCl₄ and oxygen gas to form the soot particles on the core rod. The core rod was rotated at about 60 rpm and traversed at traverse speed of about 1500 mm/min. The flow rate of hydrogen and oxygen gases to end burners provided towards opposite ends of the rod was maintained at about 35 slpm and 25 slpm respectively. It was observed that the temperature at the ends of rod was higher than the other area of the rod. This increase in temperature at the ends of the rod was observed to result in increase in density of soot deposited at the ends of the rod as compared to other areas of the rod which in-turn resulted in decrease in diameter of the soot deposited on the ends of the rod as compared to other areas of the rod. This deposition process is continued till a diameter of about 130 mm is achieved. After completion of soot deposition, rod with soot porous body was subjected to tests of cracks, breakages, bending, slippages and splits at end portions of the rod. No such problems were observed on the ends except decrease in diameter at the ends of the rod.

Experiment 2:

The above experiment 1 was repeated but an attempt was made to grow the soot porous body upto a diameter of about 180 mm while maintaining above flow rate of hydrogen and oxygen gases to the end burners. After completion of soot deposition, rod with soot porous body was subjected to tests of cracks, breakages, bending, slippages and splits at end portions of the rod. The ends of the soot porous body were observed to have said defects from about 10% to about 20% when the size of the soot porous body was at about 180 mm.

Experiment 3:

The above experiment 1 was repeated but the flow rate of hydrogen and oxygen to the end burners was maintained at about 45 slpm and 25 slpm respectively to increase the temperature of ends of rod from about 1000° C. to about 1300° C. After completion of soot deposition, rod with soot porous body was subjected to tests of cracks, breakages, bending, slippages and splits at end portions of the rod. The ends of the soot porous body were observed to have said defects from about 10% to about 20% when the diameter of the soot porous body was varying from about 130 mm to about 180 mm.

Experiment 4:

The soot porous body was deposited on a rod of diameter of about 20 mm by employing the OVD method in accordance with present invention. The initial flow rate of hydrogen and oxygen gases to the end burners was maintained at about 25 slpm and about 14 slpm respectively till the soot porous body of diameter of about 35 mm was achieved. The flow rate of hydrogen and oxygen gases was then increased to result in increase of temperature at opposite ends of the rod in a controlled manner in accordance with profile 1 of FIG. 2 to about 45 slpm and about 25 slpm respectively till the soot size was increased to about 150 mm. The flow rate of hydrogen and oxygen gases was then maintained at about 45 slpm and about 25 slpm respectively till the soot deposit was achieved at about 190 mm.

Experiment 5:

The soot porous body was deposited on a rod of diameter of about 20 mm by employing the OVD method in accordance with present invention. The initial flow rate of hydrogen and oxygen gases to the end burners was maintained at about 25 slpm and about 14 slpm respectively. The flow rate of hydrogen and oxygen gases was then increased in a controlled manner to result in increase of temperature at opposite ends of the rod in a controlled manner in accordance with profile 2 of FIG. 2 to about 45 slpm and about 25 slpm respectively till the soot size was increased to about 190 mm.

Experiment 6:

The soot porous body was deposited on a rod of diameter of about 20 mm by employing the OVD method in accordance with present invention. The initial flow rate of hydrogen and oxygen gases to the end burners was maintained at about 20 slpm and about 20 slpm respectively. The flow rate of hydrogen and oxygen gases was then increased in a controller manner while varying the oxygen/hydrogen ratio from about 1.0 to about 0.45 ratio to result in increase of temperature at opposite ends of the rod in a controlled manner in accordance with profile 3 of FIG. 2, to about 45 slpm and about 25 slpm respectively till the soot size was increased to about 185 mm.

Experiment 7:

The soot porous body was deposited on a rod of diameter of about 20 mm by employing the OVD method in accordance with present invention. The initial flow rate of hydrogen and oxygen gases to the end burners was maintained at about 20 slpm and about 20 slpm respectively. The flow rate of hydrogen and oxygen gases was then increased in a controlled manner to result in increase of temperature at opposite ends of the rod in a controlled manner in accordance with profile 4 of FIG. 2 to about 45 slpm and about 25 slpm respectively till the soot size was increased to about 170 mm.

The ends of the soot porous body deposited in accordance with Experiments 4, 5, 6 and 7 were observed to be without said defects even when the diameter of the soot porous body was about 190 mm.

In one embodiment, the present invention provides an optical fiber preform having improved effective length produced by the present method. The optical fiber preform produced according to the method of the present invention has been observed to have improved effective length by about 10 to about 25% as compared to the optical fiber preform produced by the conventional methods known in the art, and the diameter variation within the preform produced by the present method is observed to be well controlled which is about 3 mm and other characteristics of the optical fiber preform produced by the present method are also observed to be well within the limits to obtain the desired parameters, of the optical fiber to be drawn from the optical fiber preform produced by this method.

An exemplary optical fiber drawn from the optical fiber preform produced by the present method has been observed to have following characteristics:

### Physical Characteristics of the Optical Fiber Preform

| Main component | Core SiO₂/GeO₂, Clad SiO₂ | |
|---|---|---|
| Preform Diameter (O.D.) | 100 | mm (typical) |
| Diamater of rod (O.D.) | 20 | mm (typical) |
| Tolerance of O.D. | ±1 | mm |
| for within a Preform | | |
| Tolerance of O.D. | ±3 | mm |
| For Preform to Preform | | |
| Effective Preform Length | 800 to 1200 | mm |

| | |
|---|---|
| Appearance | Dust Free |

### Physical Characteristics of the Optical Fiber

| | | |
|---|---|---|
| Cladding Diameter | 125.0 + 0.7 | micro meter |
| Cladding Non-Circularity | ≦1% | |
| Core Non Circularity | ≦6% | |
| Core/Cladding | ≦0.5 | micro meter |
| Concentricity Error | | |

### Performance Characteristics of the Optical Fiber

| | | |
|---|---|---|
| Attention at 1310 nm | ≦0.34 | dB/km |
| at 1380 nm | ≦1.0 | dB/km |
| at 1550 nm | ≦0.20 | dB/km |
| Mode Field Diameter at 1310 nm | 9.2 ± 0.3 | micro meter |
| Cut-off Wavelength | 1160-1320 | nm |
| Zero Dispersion Wavelength | 1304-1322 | nm |
| Slopes at Zero Dispersion | ≦0.09 | ps/nm² · km |
| Wavelength | | |
| Dispersion Coefficient at 1550 nm | ≦17.5 | ps/nm · km |
| Dispersion Coefficient | ≦3.5 | ps/nm · km |
| in 1285-1330 nm | | |
| Macro Bend Loss at 1550 nm | ≦0.05 | dB |
| (100 turns on 60 mm diameter rod) | | |

1. (canceled)

2. A method as claimed in claim 22, wherein said minimum diameter is preferably about 35 mm, more preferably less than 60 mm.

3. A method as claimed in claim 22, wherein said intermediate diameter is preferably more than about 130 mm.

4. A method for producing an optical fiber preform having a large size soot porous body comprising following steps:
a. mounting a rod 101 on the chucks 102 and 105 of a movable lathe 100 provided with means to rotate the rod onto its own longitudinal axis in the direction shown by arrow 112, means to traverse the rod along its own longitudinal axis in the direction shown by arrow 111, one or more soot forming burners 103 provided with means to traverse the burner along the longitudinal axis of said rod and supply means 108 to supply reactant gases, and one or more heating means 110 provided towards opposite ends of said rod 101, wherein the heating means 110 are provided with means to supply oxygen and fuel gases, which in-turn are provided with means to control the flow rate of oxygen and fuel gases and/or means to control the amount of oxygen and fuel gases;
b. rotating said rod onto its own longitudinal axis in the direction of arrow 112 by said means to rotate and traversing said rod along its own longitudinal axis in the direction as shown by arrow 111 by said means to traverse;
c. directing glass forming soot materials from the soot forming burner 103 to get deposited on the surface of said rod 101 till desired amount of soot particles is deposited on said rod 101 to have soot porous body 104 of desired diameter which is transferred to a sintering furnace wherein the optical fiber preform 113 of larger size is produced, characterized in that
i) heating opposite ends of said rod 101 by said heating means 110 to achieve a predetermined temperature; and
ii) continuing said step of heating while increasing said predetermined temperature of said opposite ends of said rod 101 achieved in said step-i) and while depositing the soot particles thereon to achieve a particular temperature and a desired diameter of soot porous body.

5. A method as claimed in claim 4, wherein said predetermined temperature is about 700° C. or more.

6. A method as claimed in claim 4, wherein said predetermined temperature is increased by varying flow rate of oxygen and fuel gases to said end burners.

7. A method as claimed in claim 4, wherein said predetermined temperature is increased by changing the ratio of oxygen and fuel gases to said end burners.

8. A method as claimed in claim 4, wherein said predetermined temperature is increased to said particular temperature of about 1300° C. or more.

9. A method as claimed in claim 4, wherein said predetermined temperature is increased gradually or stepwise or non-linearly in a controlled manner.

10. A method as claimed in claim 4, wherein said predetermined temperature is increased in accordance with profile 1 or profile 2 or profile 3 or profile 4 of FIG. 2.

11. A method as claimed in claim 4, wherein said fuel gas flow rate is varied from about 20 slpm to about 45 slpm and oxygen gas flow rate is varied from about 14 slpm to about 25 slpm.

12. A method as claimed in claim 4, wherein said oxygen/fuel ratio is varied from about 1.0 to about 0.4.

13. A method as claimed in claim 4, wherein said soot porous body has a diameter of more than about 130 mm.

14. A method as claimed in claim 4, wherein said heating means are selected from a group comprising end burners, oxy-hydrogen burner/torch, plasma torch, furnace, preferably the end burners, more preferably the end burners having provision for supply of one or more gases.

15. (canceled)

16. An optical fiber preform as and when produced by a method as claimed in claim 4.

17. An optical fiber preform having larger size of a soot porous body of a diameter of more than about 130 mm.

18. An optical fiber preform as claimed in claim 17 having improved effective length by about 10 to 25% and diameter variation of about 3 mm.

19. An optical fiber as and when produced from optical fiber preform as claimed in claim 16.

20. An optical fiber as and when produced from optical fiber preform as claimed in claim 17.

21. An optical fiber preform as claimed in claim 17, wherein said diameter is varying from about 130 to about 190 mm or more.

22. A method as claimed in claim 4, wherein said step-ii) comprises following process steps:
I) continuing said step of heating from said step-i) of claim 4 while maintaining said predetermined temperature of said opposite ends of said rod 101 achieved in said step-i) of claim 4 till a soot porous body of a minimum diameter is formed;
II) continuing said step of heating from above step-I) while increasing said predetermined temperature of said opposite ends of said rod 101 achieved in above step-I) and while depositing the soot particles thereon to achieve a particular temperature and an intermediate diameter of the soot porous body; and
III) continuing said step of heating from above step-II) while maintaining said particular temperature of said opposite ends of said rod 101 achieved in above step-III) till a soot porous body of a desired diameter is formed.

23. A method as claimed in claim 13, wherein said soot porous body has a diameter varying from about 130 to about 190 mm or more.
